(19) United States
(12) Patent Application Publication
(10) Pub. No.: US 2025/0056394 A1
(43) Pub. Date: Feb. 13, 2025

(54) ASSISTANCE FOR FUNCTIONALITY SELECTION AT A NETWORK

(71) Applicant: Nokia Technologies Oy, Espoo (FI)

(72) Inventors: Prajwal KESHAVAMURTHY, Munich (DE); Taylan SAHIN, Munich (DE); Diomidis MICHALOPOULOS, Munich (DE); Endrit DOSTI, Espoo (FI)

(21) Appl. No.: 18/774,549

(22) Filed: Jul. 16, 2024

Related U.S. Application Data
(60) Provisional application No. 63/518,498, filed on Aug. 9, 2023.

(51) Int. Cl. H04W 48/18; H04W 24/02; H04W 64/00

(52) U.S. Cl. CPC H04W 48/18; H04W 24/02; H04W 64/00

(57) ABSTRACT

Methods, apparatuses, and computer program products provide means for functionality selection assistance to determine selection of a preferred functionality for an Artificial Intelligence/Machine Learning model feature. An example method includes: receiving a request for supported functionalities from a network node; identifying the supported functionalities; determining functionality selection assistance information; and providing an indication of the supported functionalities and the functionality selection assistance information to the network node. A method can optionally include receiving an indication of a selected functionality of the supported functionalities based, at least in part, on the functionality selection assistance information; and employing the selected functionality to support a feature.

### RELATED APPLICATION

This application claims priority to U.S. provisional Application No. 63/518,498 filed Aug. 9, 2023, which is incorporated herein by reference in its entirety

### TECHNOLOGICAL FIELD

An example embodiment described herein generally provides for selection of a supported functionality of an Artificial Intelligence/Machine Learning feature, and more specifically, provides for functionality selection assistance to determine selection of a preferred functionality for an Artificial Intelligence/Machine learning feature.

### BACKGROUND

Mobile devices operating on a network are capable of a wide variety of functions. The functions performed on mobile devices support features of the mobile devices. These functions are supported on local devices based on capabilities of the local device. The functions often rely upon mobile networks and support provided via network nodes to perform the functions supporting features. These wireless communication services may be provided by a mobile network (also referred to as a cellular network) in which at least the last link is wireless, and via which voice and/or data services are provided to a plurality of devices. Mobile networks may be a Third Generation (3G), a Fourth Generation (4G), and/or a next generation (e.g., Fifth Generation, or 5G) network.

Differing devices have different functionalities, while networks support various subsets of functionalities. Compatibility between networks and devices can be inefficient. Further, while devices may be capable of performing certain functions, those functions may be inefficient or poorly supported by capabilities of a device. Such issues can cause latency and poor performance, leading to user dissatisfaction.

### BRIEF SUMMARY

Various embodiments generally relate to selection of a supported functionality of an Artificial Intelligence/Machine Learning model feature, and more specifically, provides for functionality selection assistance to determine selection of a preferred functionality for an Artificial Intelligence/Machine learning model feature. Some embodiments provided herein include an apparatus embodied by a User Equipment (UE), the apparatus including at least one processor; and at least one memory including computer program code, the at least one memory and computer program code configured to, with the at least one processor, cause the apparatus to: receive a request for supported functionalities and functionality selection assistance information from a network node; identify the supported functionalities; determine the functionality selection assistance information; and provide an indication of the supported functionalities and the functionality selection assistance information to the network node. According to an embodiment, the apparatus is further configured to: receive an indication of a selected functionality of the supported functionalities based, at least in part, on the functionality selection assistance information; and employ the selected functionality to support a feature.

According to some embodiments, the supported functionalities include Artificial Intelligence (AI)/Machine Learning (ML) functionalities configured to perform the feature. The feature of an example embodiment includes an Artificial Intelligence (AI)/Machine Learning (ML) feature. According to some embodiments, the AI/ML feature includes an AI/ML-based position feature, where each of the respective supported functionalities includes a different combination of apparatus capabilities to perform the respective supported functionality. The request for supported functionalities from the network node includes, in some embodiments, a request for functionality selection assistance information.

According to some embodiments, the functionality selection assistance information includes one or more of: apparatus preference of the supported functionalities; expected quality of service of the supported functionalities; expected resource requirements of the supported functionalities; support requirements of the supported functionalities; likelihood of functionality switching between the supported functionalities within a predetermined time period; or expected interruption of the supported functionalities. The functionality selection assistance information is based, in some embodiments, on at least one of resource availability of the apparatus and resource requirements of the supported functionalities.

Another embodiment provided herein includes a computer program product having at least one non-transitory computer-readable storage medium having computer-executable program code instructions stored therein, the computer-executable program code instructions including program code instructions to: receive a request for supported functionalities and functionality selection assistance information from a network node; identify the supported functionalities; determine the functionality selection assistance information; and provide an indication of the supported functionalities and the functionality selection assistance information to the network node. According to an embodiment, the computer program product further includes program code instructions to: receive an indication of a selected functionality of the supported functionalities based, at least in part, on the functionality selection assistance information; and employ the selected functionality to support a feature.

According to some embodiments, the supported functionalities include Artificial Intelligence (AI)/Machine Learning (ML) functionalities configured to perform the feature. The feature of an example embodiment includes an Artificial Intelligence (AI)/Machine Learning (ML) feature. According to some embodiments, the AI/ML feature includes an AI/ML-based position feature, where each of the respective supported functionalities includes a different combination of apparatus capabilities to perform the respective supported functionality. The request for supported functionalities from the network node includes, in some embodiments, a request for functionality selection assistance information.

According to some embodiments, the functionality selection assistance information includes one or more of: apparatus preference of the supported functionalities; expected quality of service of the supported functionalities; expected resource requirements of the supported functionalities; support requirements of the supported functionalities; likelihood of functionality switching between the supported functionalities within a predetermined time period; or expected interruption of the supported functionalities. The functionality selection assistance information is based, in some embodiments, on at least one of resource availability of the apparatus and resource requirements of the supported functionalities.

A further embodiment provided herein includes a method including: receiving a request for supported functionalities and functionality selection assistance information from a network node; identifying the supported functionalities; determining the functionality selection assistance information; and providing an indication of the supported functionalities and the functionality selection assistance information to the network node. According to an embodiment, the method further includes: receiving an indication of a selected functionality of the supported functionalities based, at least in part, on the functionality selection assistance information; and employing the selected functionality to support a feature.

According to some embodiments, the supported functionalities include Artificial Intelligence (AI)/Machine Learning (ML) functionalities configured to perform the feature. The feature of an example embodiment includes an Artificial Intelligence (AI)/Machine Learning (ML) feature. According to some embodiments, the AI/ML feature includes an AI/ML-based position feature, where each of the respective supported functionalities includes a different combination of apparatus capabilities to perform the respective supported functionality. The request for supported functionalities from the network node includes, in some embodiments, a request for functionality selection assistance information.

According to some embodiments, the functionality selection assistance information includes one or more of: apparatus preference of the supported functionalities; expected quality of service of the supported functionalities; expected resource requirements of the supported functionalities; support requirements of the supported functionalities; likelihood of functionality switching between the supported functionalities within a predetermined time period; or expected interruption of the supported functionalities. The functionality selection assistance information is based, in some embodiments, on at least one of resource availability of the apparatus and resource requirements of the supported functionalities.

An embodiment provided herein includes an apparatus including: means for receiving a request for supported functionalities and functionality selection assistance information from a network node; means for identifying the supported functionalities; means for determining the functionality selection assistance information; and means for providing an indication of the supported functionalities and the functionality selection assistance information to the network node. An apparatus of an example further includes: means for receiving an indication of a selected functionality of the supported functionalities based, at least in part, on the functionality selection assistance information; and means for employing the selected functionality to support a feature.

According to some embodiments, the supported functionalities include Artificial Intelligence (AI)/Machine Learning (ML) functionalities configured to perform the feature. The feature of an example embodiment includes an Artificial Intelligence (AI)/Machine Learning (ML) feature. According to some embodiments, the AI/ML feature includes an AI/ML-based position feature, where each of the respective supported functionalities includes a different combination of apparatus capabilities to perform the respective supported functionality. The request for supported functionalities from the network node includes, in some embodiments, a request for functionality selection assistance information.

According to some embodiments, the functionality selection assistance information includes one or more of: apparatus preference of the supported functionalities; expected quality of service of the supported functionalities; expected resource requirements of the supported functionalities; support requirements of the supported functionalities; likelihood of functionality switching between the supported functionalities within a predetermined time period; or expected interruption of the supported functionalities. The functionality selection assistance information is based, in some embodiments, on at least one of resource availability of the apparatus and resource requirements of the supported functionalities.

Another embodiment provided herein includes an apparatus including at least one processor and at least one memory including computer program code, the at least one memory and the computer program code configured to, with the at least one processor, cause the apparatus to at least: request, of an apparatus, an identification of supported functionalities; request, of the apparatus, functionality selection assistance information; receive, from the apparatus, an identification of the supported functionalities; receive from the apparatus, the functionality selection assistance information; select a selected functionality based on the identification of supported functionalities and the functionality selection assistance information; and provide, to the apparatus, the selected functionality.

The supported functionalities, in some embodiments, include Artificial Intelligence (AI)/Machine Learning (ML) functionalities to perform a feature. The feature of some embodiments includes an Artificial Intelligence (AI)/Machine Learning (ML) feature. The AI/ML feature of some embodiments includes a position feature, where each of the respective supported functionalities includes a different combination of apparatus capabilities to perform the respective supported functionality. The apparatus capabilities of some embodiments include one or more of processing power, available memory, electrical power, apparatus input/output conditions, or apparatus connection status.

The functionality selection assistance information includes, in some embodiments, one or more of: apparatus preference of supported functionalities; expected quality of service of the supported functionalities; expected resource requirements of the supported functionalities; support requirements of the supported functionalities; likelihood of functionality switching between the supported functionalities within a predetermined time period; or expected interruption of the supported functionalities. The functionality selection assistance information is, in some embodiments, based on at least one of resource availability of the apparatus and resource requirements of the supported functionalities.

A further embodiment provided herein includes a computer program product including at least one non-transitory computer-readable storage medium having computer-executable program code instructions stored therein, the computer-executable program code instructions including program code instructions to: request, of an apparatus, an identification of supported functionalities; request, of the apparatus, functionality selection assistance information; receive, from the apparatus, an identification of the supported functionalities; receive from the apparatus, the functionality selection assistance information; select a selected functionality based on the identification of supported functionalities and the functionality selection assistance information; and provide, to the apparatus, the selected functionality.

The supported functionalities, in some embodiments, include Artificial Intelligence (AI)/Machine Learning (ML) functionalities to perform a feature. The feature of some embodiments includes an Artificial Intelligence (AI)/Machine Learning (ML) feature. The AI/ML feature of some embodiments includes a position feature, where each of the respective supported functionalities includes a different combination of apparatus capabilities to perform the respective supported functionality. The apparatus capabilities of some embodiments include one or more of processing power, available memory, electrical power, apparatus input/output conditions, or apparatus connection status.

The functionality selection assistance information includes, in some embodiments, one or more of: apparatus preference of supported functionalities; expected quality of service of the supported functionalities; expected resource requirements of the supported functionalities; support requirements of the supported functionalities; likelihood of functionality switching between the supported functionalities within a predetermined time period; or expected interruption of the supported functionalities. The functionality selection assistance information is, in some embodiments, based on at least one of resource availability of the apparatus and resource requirements of the supported functionalities.

Yet another embodiment provided herein includes a method including: requesting, of an apparatus, an identification of supported functionalities; requesting, of the apparatus, functionality selection assistance information; receiving, from the apparatus, an identification of the supported functionalities; receiving from the apparatus, the functionality selection assistance information; selecting a selected functionality based on the identification of supported functionalities and the functionality selection assistance information; and providing, to the apparatus, the selected functionality.

The supported functionalities, in some embodiments, include Artificial Intelligence (AI)/Machine Learning (ML) functionalities to perform a feature. The feature of some embodiments includes an Artificial Intelligence (AI)/Machine Learning (ML) feature. The AI/ML feature of some embodiments includes a position feature, where each of the respective supported functionalities includes a different combination of apparatus capabilities to perform the respective supported functionality. The apparatus capabilities of some embodiments include one or more of processing power, available memory, electrical power, apparatus input/output conditions, or apparatus connection status.

The functionality selection assistance information includes, in some embodiments, one or more of: apparatus preference of supported functionalities; expected quality of service of the supported functionalities; expected resource requirements of the supported functionalities; support requirements of the supported functionalities; likelihood of functionality switching between the supported functionalities within a predetermined time period; or expected interruption of the supported functionalities. The functionality selection assistance information is, in some embodiments, based on at least one of resource availability of the apparatus and resource requirements of the supported functionalities.

An embodiment provided herein includes a network node including: means for requesting, of an apparatus, an identification of supported functionalities; means for requesting, of the apparatus, functionality selection assistance information; means for receiving, from the apparatus, an identification of the supported functionalities; means for receiving from the apparatus, the functionality selection assistance information; means for selecting a selected functionality based on the identification of supported functionalities and the functionality selection assistance information; and means for providing, to the apparatus, the selected functionality.

The supported functionalities, in some embodiments, include Artificial Intelligence (AI)/Machine Learning (ML) functionalities to perform a feature. The feature of some embodiments includes an Artificial Intelligence (AI)/Machine Learning (ML) feature. The AI/ML feature of some embodiments includes a position feature, where each of the respective supported functionalities includes a different combination of apparatus capabilities to perform the respective supported functionality. The apparatus capabilities of some embodiments include one or more of processing power, available memory, electrical power, apparatus input/output conditions, or apparatus connection status.

The functionality selection assistance information includes, in some embodiments, one or more of: apparatus preference of supported functionalities; expected quality of service of the supported functionalities; expected resource requirements of the supported functionalities; support requirements of the supported functionalities; likelihood of functionality switching between the supported functionalities within a predetermined time period; or expected interruption of the supported functionalities. The functionality selection assistance information is, in some embodiments, based on at least one of resource availability of the apparatus and resource requirements of the supported functionalities.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will be appreciated that the scope encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms above, non-limiting and non-exhaustive embodiments of the subject disclosure will now be described with reference to the accompanying drawings, which are not necessarily drawn to scale. The components illustrated in the accompanying drawings may or may not be present in certain embodiments described herein. Some embodiments may include fewer (or more) components than those shown in the drawings.

FIG. 1 illustrates an overview of an example mobile network (e.g., 5GS), in accordance with various embodiments of the present disclosure;

FIG. 2 provides a block diagram of an example apparatus for functionality selection assistance in accordance with various embodiments of the present disclosure;

FIG. 3 illustrates a communication diagram of a process for functionality selection assistance between a network node and a user equipment device according to an example embodiment of the present disclosure;

FIG. 4 is a flowchart of a method for functionality selection assistance between a network node and a user equipment device according to an example embodiment of the present disclosure; and

FIG. 5 is another flowchart of a method for functionality selection assistance between a network node and a user equipment device according to an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” “electronic information,” “signal,” “command,” and similar terms may be used interchangeably to refer to data capable of being captured, transmitted, received, and/or stored in accordance with various embodiments of the present disclosure. Thus, use of any such terms should not be taken to limit the spirit and scope of embodiments of the present disclosure. Further, where a first computing device is described herein to receive data from a second computing device, it will be appreciated that the data may be received directly from the second computing device or may be received indirectly via one or more intermediary computing devices, such as, for example, one or more servers, relays, routers, network access points, base stations, hosts, repeaters, and/or the like, sometimes referred to herein as a “network.” Similarly, where a first computing device is described herein as sending data to a second computing device, it will be appreciated that the data may be sent or transmitted directly to the second computing device or may be sent or transmitted indirectly via one or more intermediary computing devices, such as, for example, one or more servers, remote servers, cloud-based servers (e.g., cloud utilities), relays, routers, network access points, base stations, hosts, repeaters, and/or the like.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

Wireless communication networks and user equipment (UE) devices thereof have an ever-increasing degree of capabilities. Further, advances in Artificial Intelligence (AI) and Machine Learning (ML) provide opportunities for AI/ML functionalities. UE devices can benefit from AI/ML functionality. For example, localization of a UE device can employ an AI/ML model. Localization of a UE device can be challenging based upon available wireless signals and localization services (e.g., Global Navigation Satellite Systems (GNSS)). Localization in environments where GNSS is weak, uncertain, or unavailable may rely upon other processes, such as wireless access point fingerprinting. An AI/ML model can be employed considering UE capabilities to satisfy a functionality that identifies a location of the UE device. For example, an AI/ML model can receive a wireless fingerprint read at a UE device, available access points or nodes, and other possible capabilities to generate and provide an output of a highly accurate position of the UE device within an environment.

Beyond localization, AI/ML models can be employed for other features. An AI/ML model can be employed for beam management. The set of Layer 1 (PHY) and Layer 2 (MAC) procedures used to establish and retain an optimal beam pair for connectivity can be enhanced and improved through use of a machine learning model. Channel State Information (CSI) feedback can be enhanced through use of AI/ML models, such as a spatial-frequency domain CSI compression using a two-sided (network and UE) AI model or a time domain CSI prediction using a UE sided AI model, for example. Additional functions can be enhanced and improved through use of AI/ML models as described herein and as will be further developed through additional applications of AI/ML models.

AI/ML models can be processing intensive, requiring significant resources. With multiple functionalities of a UE device enabling an AI/ML feature, a determination may be made with respect to employing the AI/ML functionality at the UE device. A determination of which AI/ML functionalities are enabled can consider the impact of functionality selection on the AI/ML resources at the UE, signaling overhead, and performance of the AI/ML functionality. An embodiment described herein supports functionality identification and selection for a UE that is most suitable for the UE and incurs less signaling overhead in realizing an AI/ML feature accurately and efficiently. An AI/ML feature can be realized using numerous different AI/ML functionalities, with each AI/ML functionality achieves different performance for the same AI/ML feature.

According to an example embodiment, a UE assists the network in selecting/reselecting functionality for the UE in enabling an AI/ML feature. The assistance is provided by sending functionality (re) selection assistance information from the UE to the network where, for each supported specific combination of UE conditions to enable the AI/ML feature (e.g., supported functionality) to consider various aspects of enabling the AI/ML feature. These aspects include UE preference, expected Quality of Service (QoS) performance, expected AI/ML resource requirement, AI/ML model LCM support requirement, likelihood of functionality switch request in a certain time window, and expected interruptions and duration of the interruption in certain time windows.

The UE preference consideration indicates the UE preference in selecting the associated functionality, either in terms of preference levels (e.g., low, medium, high) or preference order (numerical) in comparison to other supported functionalities. The expected QoS performance indicates the expected QoS (e.g., latency, accuracy) performance of the AI/ML enabled feature when the associated functionality is selected. The expected AI/ML resource requirement indicates the expected AI/ML resource (e.g. processing power, memory, electrical power, etc.) usage for the supported functionality. The consideration of the AI/ML model Lifecycle Management (LCM) support requirement indicates that the expected LCM operations (e.g., monitoring) and their periodicity and duration of the LCM operation and/or desired number of data samples for the operation are considered in selecting functionality for the UE in enabling the AI/ML feature. A UE device may indicate it needs more network support to enable a functionality. For example, the UE can report accuracy of the functionality and the network can identify additional support needed. The UE can determine and report to the network the cost of selecting a particular functionality, thereby assisting selection of an appropriate functionality for the UE. An embodiment can optionally be considered the likelihood of functionality switch request within a certain time window, which indicates how likely for a UE device to send a functionality switch request within a certain duration. The expected interruptions and duration of the interruptions within a certain time window are considered as they indicate the potential downtime of the functionality.

According to an example embodiment described herein, the UE device is configured to receive a request for an AI/ML functionality selection assistance information from a network node (e.g., gNodeB, location management function (LMF), etc.). The AI/ML functionality selection assistance information is determined, based at least in part, on AI/ML capabilities of the UE, AI/ML resource availability, AI/ML resource requirements, and LCM requirements of associated underlying AI/ML models of supported functionalities, where resource availability/requirements include US features such as processing power, memory, electrical power, etc. The UE then sends AI/ML functionality selection assistance information to the network node, where the assistant information contains, for each supported functionality, information on one or more of: UE preference, expected QoS performance, AI/ML model LCM support requirements, likelihood of functionality switch need in a time window, expected interruption in a time window, etc. The UE then receives an indication on the selected functionality from the network node.

According to some embodiments, the network node is configured to request a UE for AI/ML functionality selection assistance information. An AI/ML functionality is selected based at least in part, on the AI/ML functionality selection assistance information. An indication is provided to the UE of the selected AI/ML functionality.

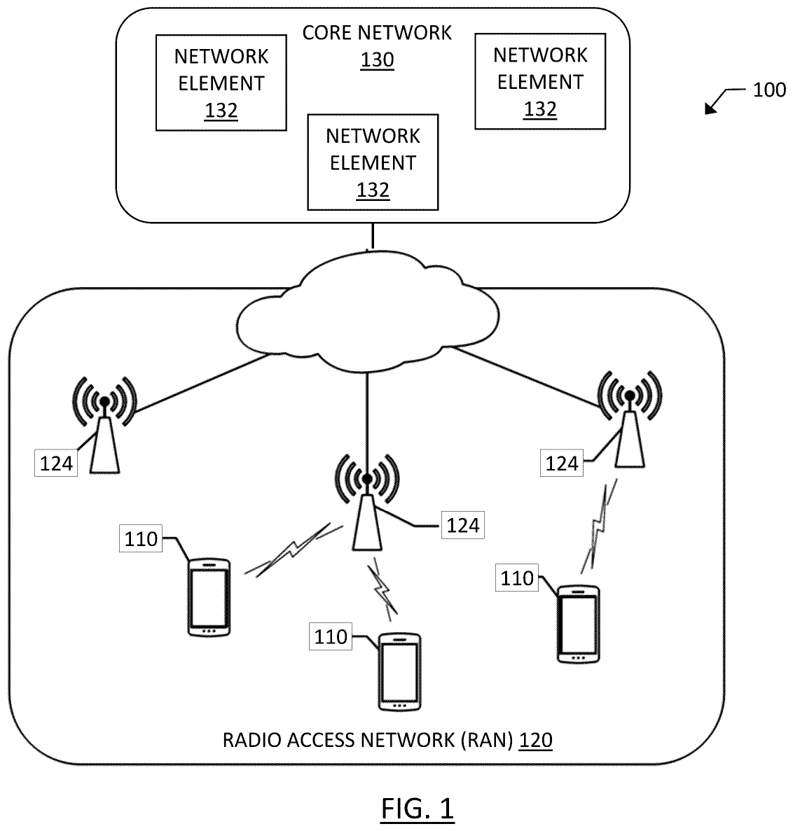

Referring now to FIG. 1, an example mobile network 100 is illustrated. Mobile network 100 (also referred to as a cellular network) is a type of network where at least the last link is wireless, and provides voice and/or data services to a plurality of devices. Mobile network 100 may be a Third Generation (3G), a Fourth Generation (4G), and/or a next generation (e.g., Fifth Generation, or 5G) network.

Mobile network 100 is illustrated as providing communication services to UEs 110. UEs 110 may be enabled for voice services, data services, Machine-to-Machine (M2M) or Machine Type Communications (MTC) services, Internet of Things (IoT) services, and/or other services. A UE 110 may be an end user device such as a mobile phone (e.g., smartphone), a tablet or PDA, a computer with a mobile broadband adapter, and/or the like.

Mobile network 100 includes one or more radio access networks (RAN 120) that communicate with UEs 110 over a radio interface. RAN 120 of one example embodiment may support Evolved-UMTS terrestrial Radio Access network (E-UTRAN) access, Wireless Local Area Network (WLAN) access, fixed access, satellite radio access, new Radio Access Technologies (RAT), and/or the like. As an example, RAN 120 may comprise an E-UTRAN or Next Generation RAN (NG-RAN) that includes one or more base stations 124 that are dispersed over a geographic area. A base station 124 may comprise an entity that uses radio communication technology to communicate with a UE on the licensed spectrum, and interface the UE with a core network 130. Base stations 124 in an E-UTRAN may be referred to as Evolved-NodeBs (eNodeB). Base stations 124 in a NG-RAN may be referred to as gNodeBs (NR base stations) and/or ng-eNodeBs (LTE base stations supporting a 5G Core Network). As another example, RAN 120 may comprise a WLAN that includes one or more Wireless Access Points (WAP). A WLAN is a network in which a UE is able to connect to a Local Area Network (LAN) through a wireless (radio) connection. A WAP is a node that uses radio communication technology to communicate with a UE over the unlicensed spectrum and provides the UE access to a core network. One example of a WAP is a Wi-Fi access point that operates on the 2.4 GHz or 5 GHz radio bands. The term “base station” then may refer to an eNodeB, a gNodeB, an ng-eNodeB, a WAP, and/or the like.

UEs 110 are able to attach to a cell of a RAN 120 to access a core network 130. RAN 120 therefore represents the radio interface between UEs 110 and core network 130. Core network 130 is the central part of mobile network 100 that provides various services to customers who are connected by RAN 120. One example of core network 130 is the Evolved Packet Core (EPC) network as described by the 3GPP for LTE. Another example of core network 130 is a 5G Core (5GC) network as described by the 3GPP. Core network 130 includes network elements 132, which may comprise servers, devices, apparatuses, or equipment (including hardware) that provide services for UEs 110. Network elements 132, in an EPC network, may comprise a Mobility Management Entity (MME), a Service Gateway (S-GW), a Packet Data Network Gateway (P-GW), and/or the like. Network elements 132, in a 5G network, may comprise an Access and Mobility Management Function (AMF), a Session Management Function (SMF), a User Plane Function (UPF), a Policy Control Function (PCF), a Unified Data Management (UDM), and/or the like.

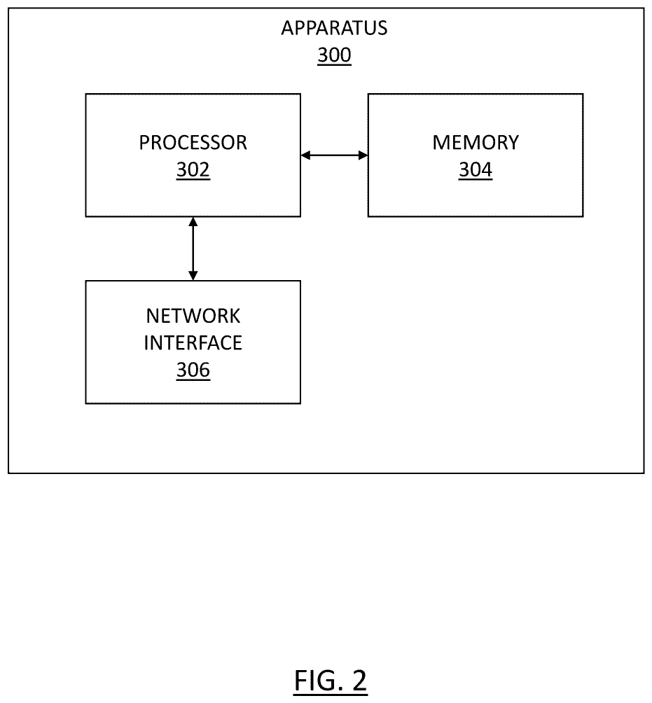

Referring now to FIG. 2, an example apparatus 300 is provided. The apparatus 300 may be an embodiment of a UE 110 and/or may be embodied by or otherwise associated with a UE 110, in some instances. Alternatively, the apparatus 300 may be an embodiment of a network element 132 or may be embodied by or otherwise associated with a network element 132, such as a PCF 260. In an example embodiment, apparatus 300 is embodied by a UE device for implementation of AI/ML functionality. An embodiment of the present disclosure provides a method that supports functionality identification and selection for such a UE that is most suitable for the UE and incurs less signaling overhead in realizing an AI/ML feature.

The apparatus 300 may include processor 302, memory 304, and network interface 306. The apparatus 300 may be configured to execute the operations described herein. Although these components are described with respect to the performance of various functions, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may be configured to store information, data, content, applications, instructions, or the like for enabling the apparatus to carry out various functions in accordance with an example embodiment disclosed herein.

The processor 302 may be embodied in a number of different ways and may, for example, include one or more processing devices configured to perform independently. In some non-limiting embodiments, the processor 302 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In some embodiments, the processor 302 may be configured to execute instructions stored in the memory 304 and/or circuitry otherwise accessible to the processor 302. In some embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment disclosed herein while configured accordingly. Alternatively, as another example, when the processor 302 is embodied as an executor of software instructions, the instructions may specifically configure the processor 302 to perform the algorithms and/or operations described herein when the instructions are executed.

The network interface 306 may be any means such as a device or circuitry embodied in either hardware or a combination of hardware and software that is configured to receive and/or transmit data from/to a network and/or any other device, circuitry, or module in communication with the apparatus 300. In this regard, the network interface 306 may include, for example, a network interface for enabling communications with a wired or wireless communication network. For example, the network interface 306 may include one or more network interface cards, antennae, buses, switches, routers, modems, and supporting hardware and/or software, or any other device suitable for enabling communications via a network. Additionally, or alternatively, the network interface 306 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

Functionality, as described herein, refers to an AI/ML-enabled feature enabled by configurations supported based on conditions indicated by UE capability. A functionality is characterized by a set of unique UE conditions that realizes a certain AI/ML feature. There may be more than one functionality defined within an AI/ML-enabled feature. Different functionalities to achieve an AI/ML-enabled feature may have different levels of accuracy, resource consumption, efficiency, and have different UE condition requirements. An embodiment described herein provides a mechanism by which the UE provides assistance for functionality selection at a network. The UE can thus establish which functionality is most appropriate given a set of circumstances or UE conditions.

The UE conditions are indicated by UE capabilities from the UE. The network can use these conditions to identify and select a functionality for the UE based on the indicated UE conditions to enable the desired AI/ML feature (e.g., direct AI/ML positioning at the UE). Subsequently, the UE can support realization of the AI/ML feature as per the indicated functionality using its AI/ML resources, such as processing resources (e.g., in the form of processor 302), memory resources (e.g., in the form of memory 304), electrical power resources (e.g., in the form of remaining battery life), and available AI/ML models. The network may not have complete knowledge of the AI/ML model details. Further, the network (or UE) performs functionality monitoring and performs functionality switching in case the performance of functionality changes, such as through degradation of performance.

Each functionality may have a different need for AI/ML resources as well as LCM needs depending upon the deployment environment (e.g., urban, highway, etc.). Hence, the functionality that is selected for the UE to enable a specific AI/ML feature has an impact on AI/ML resource usage and signaling overhead along with complexity associated with LCM (such as performance monitoring) aspects. AI/ML resource availability may be dynamic at the UE. The UE may be involved in different AI/ML tasks simultaneously. The impact of AI/ML resources may lead to increased delay in model LCM, such as in inference, training, etc., depending upon the selected functionality. Further, functionality switching incurs signaling overhead and hence selection of functionality impacts signaling overhead if it leads to frequent functionality switching.

A specific functionality is characterized by a set of specific UE conditions' range of parameter values. For a positioning use case, a functionality represents a specific configuration of a set of unique UE conditions that realizes a certain positioning feature. A specific positioning feature can be realized by several functionalities, where each functionality is configured to use certain combinations of UE conditions (in turn, UE capabilities).

A functionality is characterized by a specific set of unique UE conditions that realizes a certain AI/ML feature. The specific set of UE conditions is associated with one or more underlying AI/ML model(s). Each functionality is supported by one or more underlying AI/ML model(s). Details on the underlying model, such as AI/ML resource needs of the model, may not be sufficiently known at the network and at least some aspects, if not all of the model LCM may be transparent to the network. Further, different AI/ML models may have different complexities, AI/ML resource requirements, and support different QoS (e.g., accuracy) levels and generation performance. Still further, the AI/ML resources availability may dynamically vary at the UE. Hence, particularly when multiple functionalities are supported at a UE enabling an AI/ML feature, the determination of which functionality is selected must take into account the impact of functionality selection on the AI/ML resources as the UE, signaling overhead, and performance of the AI/ML feature.

According to example embodiments described herein, the AI/ML resources at the UE can include: processing power (e.g., Graphics Processing Unit (GPU), Computing Processing Unit (CPU), Tensor Processing Unit (TPU), etc.), available memory (e.g., Random Access Memory (RAM), Read Only Memory (ROM), etc.), electrical power (e.g., battery status), device input/output conditions (e.g., sensor blocked, sensor data missing, etc.), and device connection status (e.g., upload/download throughput, link quality, etc.).

A UE device assists the network in (re)selecting functionality by sending functionality (re)selection assistance information. The assistance information message includes a list of supported set of UE conditions, which for simplicity is referred to as functionality hence forth, even though the functionality may be identified after reporting sets of UE conditions. For each functionality, one or more elements of assistance information is provided. These include the UE preference order, the expected QoS, the AI/ML model LCM support requirement, the likelihood of functionality switch requests within a particular duration, or the expected interruptions and duration of the interruption in a particular time window. Each of which is further detailed below.

A UE preference order can include where a UE device supports multiple functionalities and may prefer one functionality over another given its AI/ML resource availability. For example, when the electrical power availability is relatively lower, the UE may prefer a functionality that consumes less power. For different functionalities, a UE device may use different AI/ML models and hence the AI/ML resource needs may be different. A UE preference may be established by a variety of factors. For example, a UE may have a need for establishing a location of the UE, though the accuracy of the needed location may be low given a circumstance. The UE may have competing needs for other resource-consuming services, such that the UE would prefer to dedicate fewer resources to localization of the UE. In such a scenario, the UE preference can indicate that a specific functionality that has relatively lower resource requirements is preferred for obtaining the AI/ML location feature.

For the expected QoS (e.g., latency, accuracy) performance, depending on the AI/ML resource availability at the UE device and underlying model's AI/ML resource demands, there may be additional delay in executing an AI/ML task (e.g., model inference). This may result in additional delay or latency. Further, the underlying models associated with different functionalities may have different accuracy performance.

The AI/ML model LCM support requirement may include how frequently the performance monitoring is to be performed, or how much data (e.g., in terms of number of data samples) needed for AI/ML model LCM purposes. The underlying AI/ML model(s) associated with functionality may have different generalization performance. Accordingly, given the mobility of the UE device, the performance monitoring needs may vary depending on the mobility pattern in certain regions or with certain environments.

The likelihood of functionality switch requests within a certain duration can reflect with a given AI/ML resource availability, the underlying models and mobility pattern of the UE device, a UE may compute and indicate the likelihood of a need for functionality switch in a given time window.

Expected interruptions and duration of the interruptions in a certain time window can reflect where a UE device may not be able to support a functionality temporarily due to AI/ML resource constraints. In such a case, the expected interruptions and durations can be indicated if there is any anticipated potential downtime for a functionality considering the available AI/ML resources and expected usage of AI/ML resource consumption by the functionality and other tasks that are being/planned to be executed at the UE device.

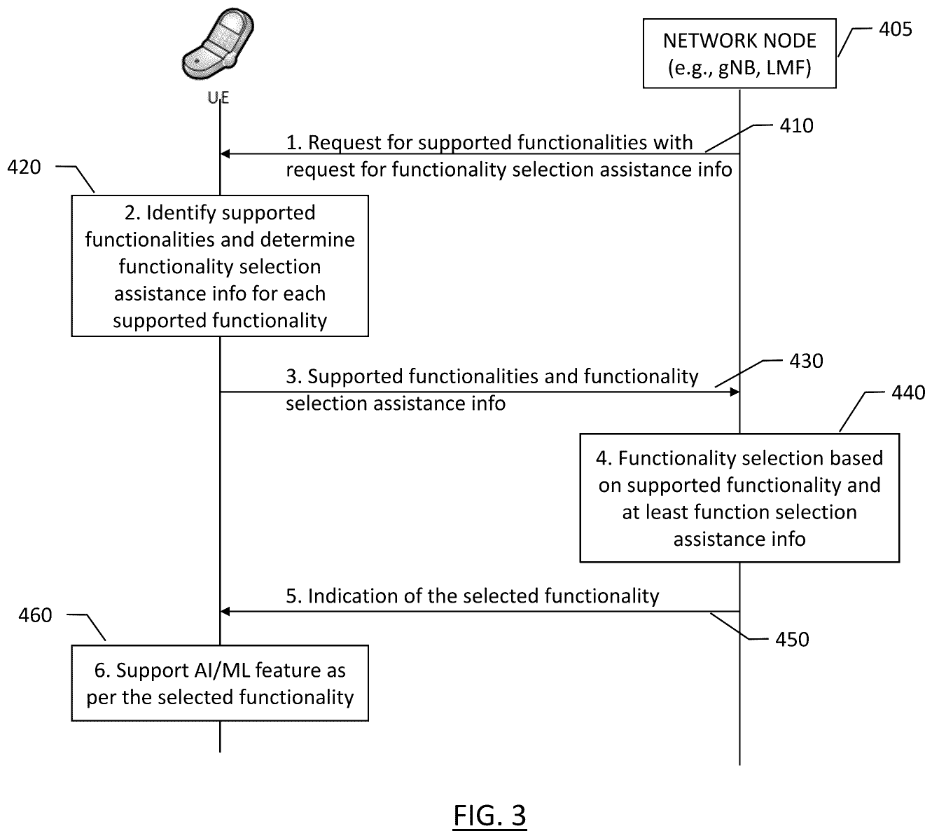

FIG. 3 illustrates an example embodiment of the message flow for UE assistance for functionality (re)selection at a network. As shown, to support a use case such as an AI/ML assisted positioning involving a UE, a network node (e.g., gNB, LMF) is in need of (re)selecting an appropriate functionality for the UE. The network node 405 at 410 requests the UE for a list of supported functionalities. The request for supported functionalities identifies what functionalities the UE is capable of supporting for an AI/ML feature. The request of 410 also includes a request for functionality selection assistance information from the UE.

The UE, at 420, identifies supported functionalities and determines functionality selection assistance information for each supported functionality. The supported functionalities are based on the capabilities of the UE, such as battery life, processing capacity, available nodes, or other factors that determine resources available to the UE to perform a functionality. Of the supported functionalities, the functionality selection assistance information pertains to the aforementioned conditions such as UE preference, expected QoS, expected AI/ML resource requirements, AI/ML model LCM support required, likelihood of functionality switch, and expected interruptions. The UE functionality selection assistance information for each supported functionality is based on, among other factors, AI/ML resource availability, AI/ML resource requirements and LCM requirements of associated underlying AI/ML models of supported functionalities.

The UE, at 430, reports not only the supported functionalities, but also the functionality selection assistance information to the network 405. The network node identifies the supported functionalities as a list of available functionalities from which to select, and uses as an input the functionality selection assistance information at 440 to identify the most appropriate functionality of the supported functionalities. The network identifies the most appropriate functionality based on a combination of factors including one or more of the UE preference, the QoS of the supported functionalities, expected AI/ML resource requirements of the supported functionality, the least AI/ML model LCM support requirements, a low likelihood of functional switch necessity (e.g., within a predetermined time interval), or a low probability of expected interruptions (e.g., within a predetermined time interval). The most appropriate functionality can optionally be determined based on internal network conditions (e.g., cell load, UE history of being able to support the provided functionalities, etc.). The network may choose to consider a part of the functionality selection assistance information and not rely on that information exclusively for selection of the most appropriate functionality. The most appropriate functionality is selected as the selected functionality and the selected functionality is indicated to the UE at 450. The UE supports the AI/ML feature based on the selected functionality at 460.

An example embodiment described herein consider the UE itself when determining a functionality to be supported by the UE. While a network can select a functionality for a UE device based on the capabilities of that UE device and what is supported at the UE device, an embodiment provided herein improves upon this functionality selection by considering a variety of factors that are UE-specific in establishing a functionality to employ at the UE. This can improve performance of the UE which in-turn provides a better user experience which benefits both the user and the service provider.

An embodiment described herein provides a clear improvement to the functioning of a computer itself. Specifically, an example embodiment enables an apparatus, such as a UE device, to identify supported functionalities and to establish functionality selection assistance information. This functionality selection assistance information provides UE preference information that is predicated on various features of the UE and priorities of actions performed by the UE. The functionality selection assistance information further establishes expected quality of service performance with respect to latency, accuracy, and the like for performance of an AI/ML enabled feature when the associated functionality is selected. This enables the most efficient and effective functionality to be selected to improve the quality of service by reducing latency and increasing accuracy when available. The functionality selection assistance information further provides the AI/ML model LCP support requirement which indicates the excepted LCM operations necessary for functionality. The UE device may indicate it needs more support from a network to enable functionality and provides an estimate of what specific functionalities will cost a network in terms of support. This enables the network to determine available capacity for support to establish if such a functionality is feasible. The functionality selection assistance information can further include a likelihood of functionality switching requests during a certain time window. If a functionality is switched, inefficiencies can be introduced such that the likelihood of a functionality being switched can indicate functionalities that will not reliably be implemented at the UE device. The functionality selection assistance information can still further include expected interruptions and durations of interruptions during a period of time, which enables a functionality to be selected that minimizes expected interruptions to improve the functioning of the AI/ML model feature itself. Therefore, an embodiment described herein is specifically geared toward improving the functionality of a computing device itself through the functionality selection assistance information.

Notwithstanding the above, the functionality selection assistance information is implemented in a practical application of supporting an AI/ML model feature, such as localization/positioning, beam management, and CSI feedback enhancement. The AI/ML model feature operation on the UE device is improved through spatial-frequency domain CSID compression using an Al model. Beam management as a practical application enables spatial-domain downlink beam prediction for a set of beams based on measurements results from another set of beams. The temporal downlink beam prediction for a first set of beams can be based on the historic measurement results of a second set of beams using an AI/ML model as described herein. Further, the AI/ML model can provide positioning enhancements through direct AI/ML positioning, such as using AI/ML model output for a UE location. Positioning is enhanced by certain example embodiments described herein through fingerprinting based on channel observation as an input to the AI/ML model, with output being a more accurate position. An embodiment described herein is implemented into a variety of practical applications and benefit each of these applications through the unique provision of functionality selection assistance using UE capabilities.

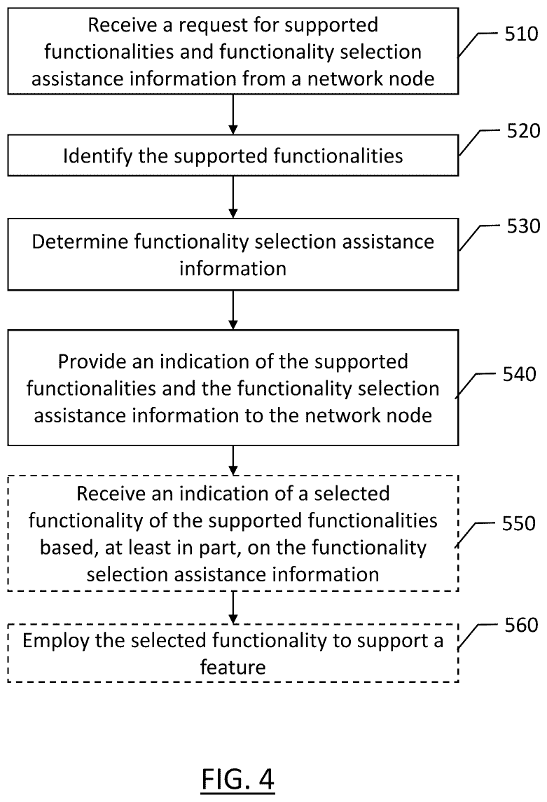

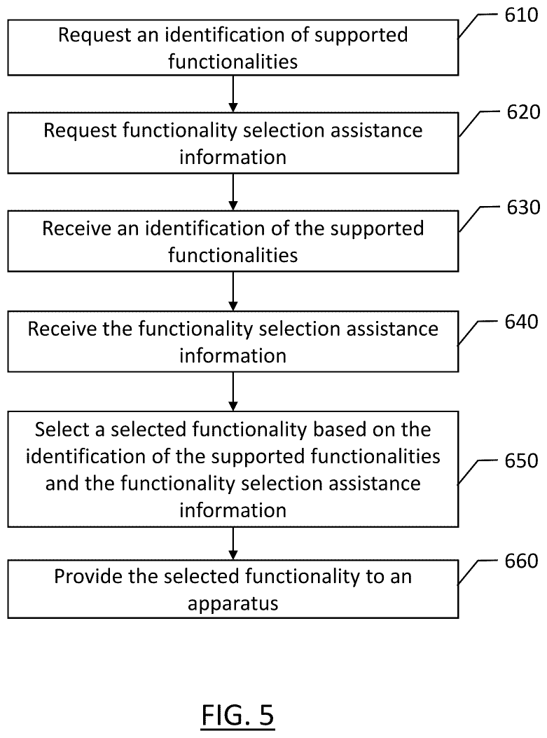

FIGS. 4 and 5 illustrate flowcharts of example embodiments of methods to provide functionality selection assistance to determine selection of a preferred functionality for an Artificial Intelligence/Machine Learning model feature. As shown in FIG. 4, a request for supported functionalities and functionality selection assistance information is received from a network node at 510. This request may be received by means, such as, for example, by network interface 306 and/or processor 302 of a UE device embodied by apparatus 300. The supported functionalities are identified at 520, and functionality selection assistance information is determined at 530. This may be performed by means, such as, for example, by processor 302 of a UE device. An indication of the supported functionalities and the functionality selection assistance information is provided to the network node at 540. This may be performed by means, such as, for example, by network interface 306 and/or processor 302 of a UE device embodied by apparatus 300. Optionally, as indicated in the dashed lines of element 550, an indication of a selected functionality of the supported functionality is received at 550 based, at least in part, on the functionality selection assistance information. This indication may be received at a UE device, such as by means, such as network interface 306 or processor 302 of apparatus 300. The selected functionality is employed to support a feature at 560. This may be performed by means, such as, for example, by processor 302 of a UE device embodied by apparatus 300. The selected functionality can include a functionality employing capabilities of the UE device to perform a feature, such as a positioning feature of the UE device using a UE-side AI/ML model.

FIG. 5 illustrates another process for selection of a functionality using functionality selection assistance information as described herein. A request is made for identification of supported functionalities at 610. This request may be made by means, such as the processor 302 of a network node embodied by apparatus 300 for generating the request and the network interface 306 for transmitting the request. A request is made at 620 for functionality selection assistance information. This request may also be made by means, such as the processor 302 of a network node embodied by apparatus 300 for generating the request and the network interface 306 for transmitting the request. The requests may be directed, for example, to a UE device where a functionality is to be performed to accomplish a feature. An indication of the supported functionalities is received at 630, and the functionality selection assistance information is received at 640. These may be received by means, such as the processor 302 and/or the network interface 306 of a network node embodied by apparatus 300. At 650, selection of a selected functionality is performed based on the identification of the supported functionalities and the functionality selection assistance information. This selection may be performed by means, such as, for example, by processor 302 of a network node embodied by apparatus 300. The selected functionality is provided to an apparatus at 660, where the apparatus may include a UE device, and the selected functionality is provided by means, such as the processor 302 and/or the network interface 306 of a network node embodied by apparatus 300.

FIGS. 4 and 5 illustrate flowcharts depicting operations according to example embodiments of the present disclosure. It will be understood that each block of the flowcharts and combination of blocks in the flowchart may be implemented by various means, such as hardware, firmware, processor, circuitry, and/or other communication devices associated with execution of software including one or more computer program instructions. For example, one or more of the procedures or operations described above may be embodied by computer program instructions. In this regard, the computer program instructions which embody the procedures or operations described above may be stored by a memory 304 of an apparatus (e.g., apparatus 300, UE 110) employing an embodiment of the present invention and executed by a processor 302. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An apparatus, comprising:
at least one processor; and
at least one memory including computer program code,
the at least one memory and the computer program code configured to, with the at least one processor, cause the apparatus at least to:
receive a request for supported functionalities and functionality selection assistance information from a network node;
identify the supported functionalities;
determine the functionality selection assistance information; and
provide an indication of the supported functionalities and the functionality selection assistance information to the network node.

2. The apparatus of claim 1, wherein the apparatus is further caused to:
receive an indication of a selected functionality of the supported functionalities, wherein the selected functionality is selected based at least in part on the functionality selection assistance information; and
employ the selected functionality to support a feature.

3. The apparatus of claim 2, wherein the supported functionalities comprise Artificial Intelligence (AI)/Machine Learning (ML) functionalities configured to perform the feature.

4. The apparatus of claim 2, wherein the feature comprises an Artificial Intelligence (AI)/Machine Learning (ML) feature.

5. The apparatus of claim 4, wherein the AI/ML feature comprises an AI/ML-based position feature, wherein each respective supported functionality comprises a different combination of apparatus capabilities to perform the respective supported functionality.

6. The apparatus of claim 1, wherein the request for supported functionalities from the network node comprises a request for functionality selection assistance information.

7. The apparatus of claim 1, wherein the functionality selection assistance information comprises one or more of:
apparatus preference of the supported functionalities;
expected quality of service of the supported functionalities;
expected resource requirements of the supported functionalities;
support requirements of the supported functionalities;
likelihood of functionality switching between the supported functionalities within a predetermined time period; or
expected interruption of the supported functionalities.

8. The apparatus of claim 1, wherein the functionality selection assistance information is based on at least one of resource availability of the apparatus or resource requirements of the supported functionalities.

9. An apparatus comprising:
at least one processor; and
at least one memory including computer program code,
the at least one memory and the computer program code configured to, with the at least one processor, cause the apparatus at least to:
request, of a user equipment, supported functionalities and functionality selection assistance information;
receive, from the user equipment, the supported functionalities and functionality selection assistance information;
select a functionality based on the supported functionalities and the functionality selection assistance information; and
cause the selected functionality to be provided to the user equipment.

10. The apparatus of claim 9, wherein the supported functionalities comprise Artificial Intelligence (AI)/Machine Learning (ML) functionalities configured to perform a feature.

11. The apparatus of claim 10, wherein the feature comprises an Artificial Intelligence (AI)/Machine Learning (ML) feature.

12. The apparatus of claim 11, wherein the AI/ML feature comprises a position feature, wherein each respective supported functionality comprises a different combination of apparatus capabilities to perform the respective supported functionality.

13. The apparatus of claim 12, wherein the apparatus capabilities include one or more of processing power, available memory, electrical power, apparatus input/output conditions, or apparatus connection status.

14. The apparatus of claim 9, wherein the functionality selection assistance information comprises one or more of:
User equipment preference of the supported functionalities;
expected quality of service of the supported functionalities;
expected resource requirements of the supported functionalities;
support requirements of the supported functionalities;
likelihood of functionality switching between the supported functionalities within a predetermined time period; or
expected interruption of the supported functionalities.

15. The apparatus of claim 9, wherein the functionality selection assistance information is based on at least one of resource availability of the user equipment or resource requirements of the supported functionalities.

16. A method comprising:
receiving a request for supported functionalities and functionality selection assistance information from a network node;
identifying the supported functionalities;
determining the functionality selection assistance information; and
providing an indication of the supported functionalities and the functionality selection assistance information to the network node.

17. The method of claim 16, further comprising:
receiving an indication of a selected functionality of the supported functionalities, wherein the selected functionality is selected based at least in part on the functionality selection assistance information; and
employing the selected functionality to support a feature.

18. The method of claim 17, wherein the supported functionalities comprise functionalities configured to perform the feature, wherein the feature comprises an Artificial Intelligence (AI)/Machine Learning (ML) position feature, wherein each respective supported functionality comprises a different combination of apparatus capabilities to perform the respective supported functionality.

19. The method of claim 16, wherein the functionality selection assistance information comprises one or more of:
apparatus preference of the supported functionalities;
expected quality of service of the supported functionalities;
expected resource requirements of the supported functionalities;
support requirements of the supported functionalities;
likelihood of functionality switching between the supported functionalities within a predetermined time period; or
expected interruption of the supported functionalities.

20. The method of claim 16, wherein the functionality selection assistance information is based on at least one of resource availability or resource requirements of the supported functionalities.
